(19) United States
(12) Patent Application Publication
(10) Pub. No.: US 2025/0136191 A1
(43) Pub. Date: May 1, 2025

(54) Contoured Truck Bed Bulkhead Panel and Bracket

(71) Applicant: Leer Group, Elkhart, IN (US)

(72) Inventor: Eugene A. Dylewski, II, Granger, IN (US)

(21) Appl. No.: 18/925,540

(22) Filed: Oct. 24, 2024

Related U.S. Application Data
(60) Provisional application No. 63/546,545, filed on Oct. 31, 2023.

(51) Int. Cl. B62D 33/02; B62D 33/04

(52) U.S. Cl. CPC B62D 33/02; B62D 33/04

(57) ABSTRACT

A contour filler bracket for use on a bulkhead of a cargo box of a pickup truck, wherein the bulkhead has a nonlinear top edge contour, and a tonneau cover panel is provided. The contour filler bracket includes a longitudinally extending bracket member having a front edge and a rear edge spaced apart from the front edge. The front edge of the bracket member at least approximates at least a portion of the nonlinear top edge contour of the bulkhead. A front edge of the tonneau cover panel is configured to overlap the rear edge of the bracket member to shroud at least a portion of the cargo box adjacent the bulkhead. A tonneau cover assembly for use on a cargo box of a pickup truck having a bulkhead with a nonlinear top edge contour is also provided. The tonneau cover assembly includes a bulkhead panel configured to shroud at least a portion of the cargo box. The bulkhead panel includes a nonlinear leading edge that at least approximates at least a portion of the nonlinear top edge contour of the bulkhead.

### RELATED APPLICATIONS

The present Application relates to and claims priority to U.S. Provisional Patent Application, Ser. No. 63/546,545, filed on Oct. 31, 2023, entitled “Contoured Truck Bed Bulkhead Panel Assembly.” The subject matter disclosed in that Provisional Application is hereby expressly incorporated into the past Application.

### TECHNICAL FIELD AND SUMMARY

The present disclosure relates to trucks, such as pickup trucks, and truck beds used on pickup trucks and like vehicles. In particular, the present disclosure relates to tonneau covers that fit on irregularly-shaped bulkheads.

The bulkhead portion of the cargo box is the forwardmost wall located behind the cab and opposite the tailgate. The bulkhead extends between the sidewalls of the cargo box. Typically, the bulkhead has a linear top edge profile (i.e., straight-line) from sidewall to opposing sidewall. Some truck designs, however, include cargo box bulkheads that are no longer linear. Rather, they can have angled, scalloped, or otherwise irregularly shaped wall and/or top edge profiles. Tonneau covers, however, have been designed to cover cargo boxes with a square or rectangular footprint with linear walls, bulkheads, and tailgates. Accordingly, the tonneau cover has the same square or rectangular shape to correspond to that footprint. If cargo boxes no longer have completely linear sidewalls or bulkheads, such tonneau covers may have difficulty fully covering or properly covering the cargo box. In addition, an irregularly shaped bulkhead wall or top edge might aesthetically make the tonneau cover fit on top and look awkward because it no longer matches the outline of the cargo box.

Accordingly, an illustrative embodiment of the present disclosure provides a contour filler bracket for use on a bulkhead of a cargo box of a pickup truck, wherein the bulkhead has a nonlinear top edge contour, and a tonneau cover panel. The contour filler bracket includes a longitudinally extending bracket member having a front edge and a rear edge spaced apart from the front edge. The bracket member is configured to extend substantially a length of the nonlinear top edge contour of the bulkhead between spaced apart sidewalls of the cargo box. At least a portion of the bracket member is seated on top of the bulkhead. The front edge of the bracket member at least approximates the nonlinear top edge contour of the bulkhead. The rear edge of the bracket member is linearly extending. A front edge of the tonneau cover panel is configured to overlap the rear edge of the bracket member to shroud a portion of the cargo box adjacent the bulkhead. The bracket member includes a ledge portion extending between the front edge and the rear edge, and a flange portion that extends from the rear edge of the bracket member.

In the above and other illustrative embodiments, the contour filler bracket may further comprise: the flange portion extends transverse with respect to the ledge portion; the flange portion is secured to the bulkhead; the flange portion includes at least one opening configured to receive a fastener that secures to the bulkhead; a gasket that extends longitudinally under the bracket member; the flange portion secures to the bulkhead; and the gasket is configured to be located between the bracket member and the bulkhead. Another illustrative embodiment of the present disclosure provides a contour filler bracket for use on a bulkhead of a cargo box of a pickup truck, wherein the bulkhead has a nonlinear top edge contour, and a tonneau cover panel. The contour filler bracket includes a longitudinally extending bracket member having a front edge and a rear edge spaced apart from the front edge. The front edge of the bracket member at least approximates at least a portion of the nonlinear top edge contour of the bulkhead. A front edge of the tonneau cover panel is configured to overlap the rear edge of the bracket member to shroud at least a portion of the cargo box adjacent the bulkhead.

In the above and other illustrative embodiments, the contour filler bracket may further comprise: the bracket member is configured to extend substantially a length of the nonlinear top edge contour of the bulkhead between spaced apart sidewalls of the cargo box; at least a portion of the bracket member is seated on top of the bulkhead; the rear edge of the bracket member is linearly extending; the bracket member includes a ledge portion extending between the front edge and the rear edge, and a flange portion that extends from the rear edge of the bracket member; the flange portion extends transverse with respect to the ledge portion; the flange portion is secured to the bulkhead; a gasket that extends longitudinally under the bracket member; the gasket is configured to be located between the bracket member and the bulkhead.

Another illustrative embodiment of the present disclosure provides a tonneau cover assembly for use on a cargo box of a pickup truck having a bulkhead with a nonlinear top edge contour. The tonneau cover assembly includes a bulkhead panel configured to shroud at least a portion of the cargo box. The bulkhead panel includes a nonlinear leading edge that at least approximates at least a portion of the nonlinear top edge contour of the bulkhead. At least a portion of the nonlinear leading edge the bulkhead panel is configured to overlap at least a portion of the bulkhead to shroud the at least the portion of the cargo box adjacent the bulkhead.

In the above and other illustrative embodiments, the tonneau cover assembly may further comprise: a gasket that extends longitudinally under the bulkhead panel; and the gasket being configured to be located between the bulkhead panel and the bulkhead.

Additional features and advantages of the contoured cargo box bulkhead panel and bracket will become apparent to those skilled in the art upon consideration of the following detailed descriptions of carrying out this contoured cargo box bulkhead panel and bracket as presently perceived.

### BRIEF DESCRIPTION OF THE DRAWINGS

The present disclosure will be described hereafter with reference to the attached drawings which are given as non-limiting examples only, in which:

FIG. 1 is a forward-looking perspective partially exploded view of a front portion of a cargo box and a bulkhead panel located thereabove;

FIG. 2 is a top detail view of the forward portion of the cargo box showing the bulkhead, sidewalls, and floor;

FIG. 3 is a detailed perspective view of the cargo box including a sidewall and bulkhead;

FIG. 4 is a top view of the forward portion of the cargo box with the bulkhead panel of a tonneau cover located thereon;

FIG. 5 is a detail exploded perspective view of the cargo box with a bulkhead panel and contour filler bracket or bar;

FIG. 6 is another perspective partially exploded view of the cargo box and a bulkhead panel located thereabove;

FIG. 7 is another top view of the forward end portion of the cargo box with a contour filler bracket or bar located on the bulkhead;

FIG. 8 is another top view of the forward portion of the cargo box with the contour filler bracket or bar and bulkhead panel from the tonneau cover located thereon;

FIG. 9 is another detailed perspective view of the cargo box sidewalls and bulkhead;

FIG. 10 is a detailed perspective view of the cargo box including the contour filler bracket or bar located thereon;

FIG. 11 is another detailed perspective view of the cargo box with the contour filler bracket or bar located thereon;

FIG. 12 is a detail perspective exploded view of the forward corner of the cargo box including the contour filler bracket or bar and a gasket;

FIG. 13 is a side sectional view of the bulkhead and tonneau cover with the bulkhead panel, contour filler bracket or bar, and gasket, coupled thereto;

FIG. 14 is a detail perspective view of a portion of an illustrative embodiment of a bulkhead panel;

FIG. 15 is a detail exploded perspective view of the front corner of the cargo box with the illustrative embodiment of the bulkhead panel; and

FIG. 16 is a side sectional view of the bulkhead with the illustrative embodiment of the tonneau cover and gasket located thereon.

Corresponding reference characters indicate corresponding parts throughout the several views. The exemplification set out herein illustrates embodiments of the contoured cargo box bulkhead panel and bracket and such exemplification is not to be construed as limiting the scope of the contoured cargo box bulkhead panel and bracket in any manner.

### DETAILED DESCRIPTION OF THE DRAWINGS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

An illustrative embodiment of the present disclosure provides a contour filler bracket or bar positionable adjacent a non-linear bulkhead of a cargo box to space the leading edge of a bulkhead panel portion of the tonneau cover from the bulkhead. The leading edge portion of the contour filler bracket or bar may approximate or match the irregular contour of the nonlinear bulkhead while the trailing portion of the contour bracket has a linear profile to complement the linear profile of the leading edge of the bulkhead panel. With the leading edge of the bracket matching or approximating the contour of the bulkhead, the combination of the contour filler bracket and bulkhead panel cover the shape of the cargo box without the leading of the bulkhead panel extending forward of the irregular sections of the bulkhead. In other words, the contour filler bracket provides a contoured leading edge and a linear trailing edge, the latter of which the leading edge of the bulkhead panel can be positioned adjacent so the forward section of the cargo box can be covered while accommodating the irregular shape of the bulkhead. This can ensure full coverage of the cargo box, as well as provide a more aesthetic appearance of the tonneau cover on the cargo box.

In another illustrative embodiment, the leading edge of the bulkhead panel may itself have a contour that matches or approximates the contour of the bulkhead. This, again, allows the tonneau cover to fully shroud the leading portion of the cargo box without extending forward of the bulkhead.

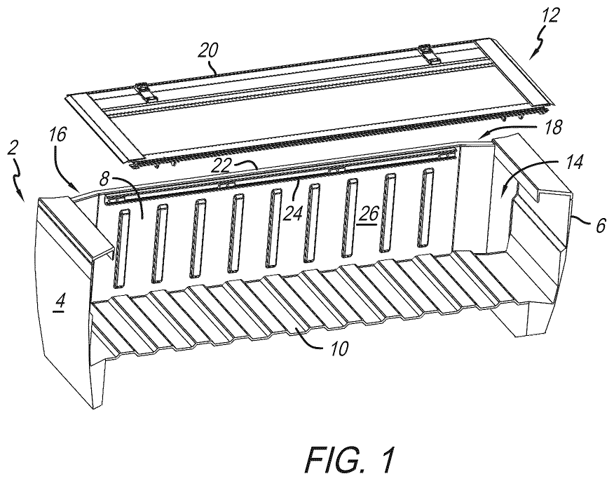

A forward-looking perspective view of the front portion of cargo box 2 is shown in FIG. 1. Cargo box 2 includes sidewalls 4 and 6, as well as bulkhead 8 and floor 10. Bulkhead panel 12 from a tonneau cover is configured to shroud opening 14 of cargo box 2 as shown in exploded view. Cargo box 2, shown herein, is different from other cargo boxes in that the bulkhead extending from sidewall 4 to sidewall 6 is not linear. Instead, angled portions 16 and 18 of bulkhead 8 are located adjacent to sidewalls 4 and 6, respectively, thereby changing the shape of bulkhead 8. In contrast, leading edge 20 of bulkhead panel 12 is linear. Thus, leading edge 20 of bulkhead panel 12 does not align with the full extent of top edge 22 of bulkhead 8. Also shown in this view is track 24 attached to inner surface 26 of bulkhead 8. As is conventional with cargo box designs, tracks, such as track 24, may serve the dual purpose of being an accessory track to attach various accessories, as well as a stiffening bracket to provide rigidity to the bulkhead depending on the manner in which it is manufactured. In this view, it is appreciated how the leading edge 20 of bulkhead panel 12 does not match top edge 22 of bulkhead 8.

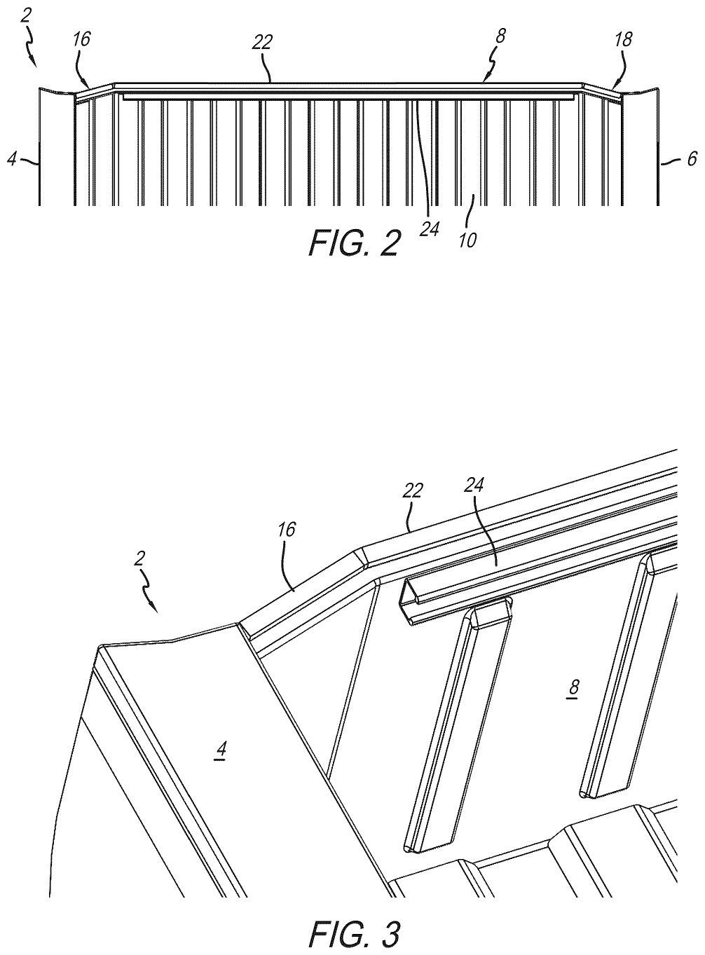

A top detail view of the forward portion of cargo box 2 showing bulkhead 8, sidewalls 4 and 6, as well as floor 10, is shown in FIG. 2. This view further demonstrates how top edge 22 of bulkhead 8 is not extending completely linearly from sidewall 4 to sidewall 6. Instead, angled portions 16 and 18 are each shown adjacent respective sidewalls 4 and 6. Also shown in this view is track 24 positioned onto bulkhead 8.

A detail perspective view of cargo box 2, including sidewall 4 and bulkhead 8, is shown in FIG. 3. Also shown is a portion of floor 10 and track 24. This view further depicts angled portions 16 of bulkhead 8 forming an irregular shape of same. This extends up to top edge 22. It is further appreciated in this view and in FIG. 2, how bulkhead 8 no longer has a linear profile extending from sidewall 4 to sidewall 6. It is appreciated that this configuration shown in FIG. 3, between sidewall 4 and angled portion 16 of bulkhead 8, is the same on the other side of the cargo box at sidewall 6 and angled portion 18 (see FIG. 2).

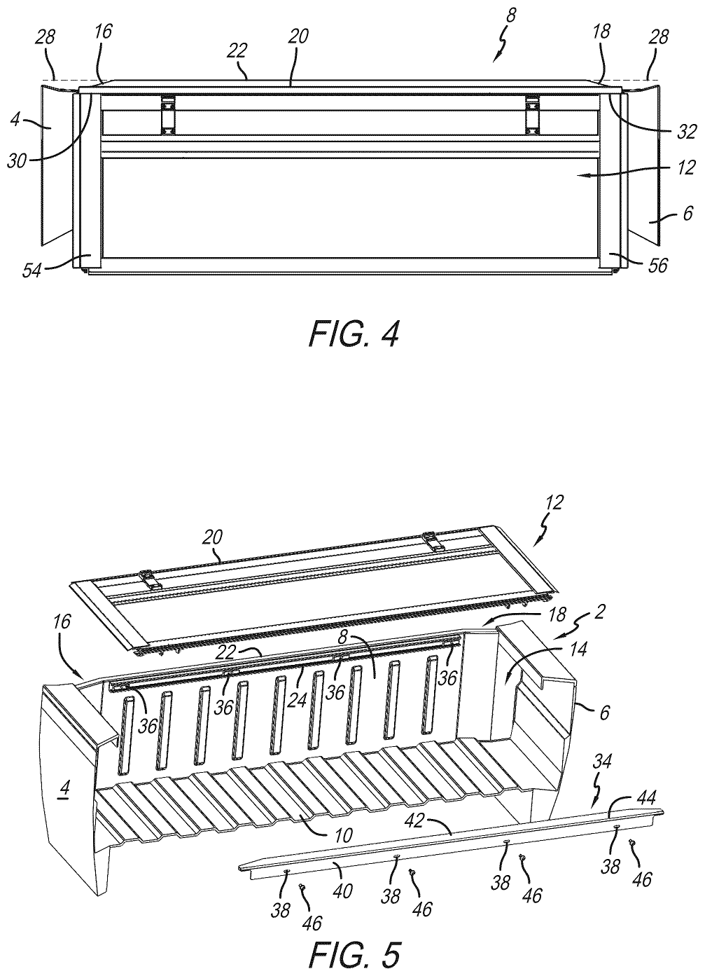

A top view of the forward portion of cargo box 2, with bulkhead panel 12 from a tonneau cover located thereon, is shown in FIG. 4. This view further demonstrates how the linear leading edge 20 of bulkhead panel 12, being linear from edge to edge, does not match the irregular contours of top edge 22 of bulkhead 8. Dashed lines 28 shown herein further illustrate how angled portions 16 and 18 of bulkhead 8 no longer create a linear profile of bulkhead 8 from sidewall 4 to sidewall 6. As a result, portion 30 and 32 of bulkhead panel 12, adjacent leading and edge 20, extends over and forward of angled portions 16 and 18, respectively, failing to align with the full top edge 22 of bulkhead 8.

In order to prevent this type of overlap, a contour filler bracket 34 may be placed onto bulkhead 8 to accommodate bulkhead panel 12 so it can shroud the forward portion of cargo box 2 without hanging over forward the non-linear, irregularly-shaped, profile of same.

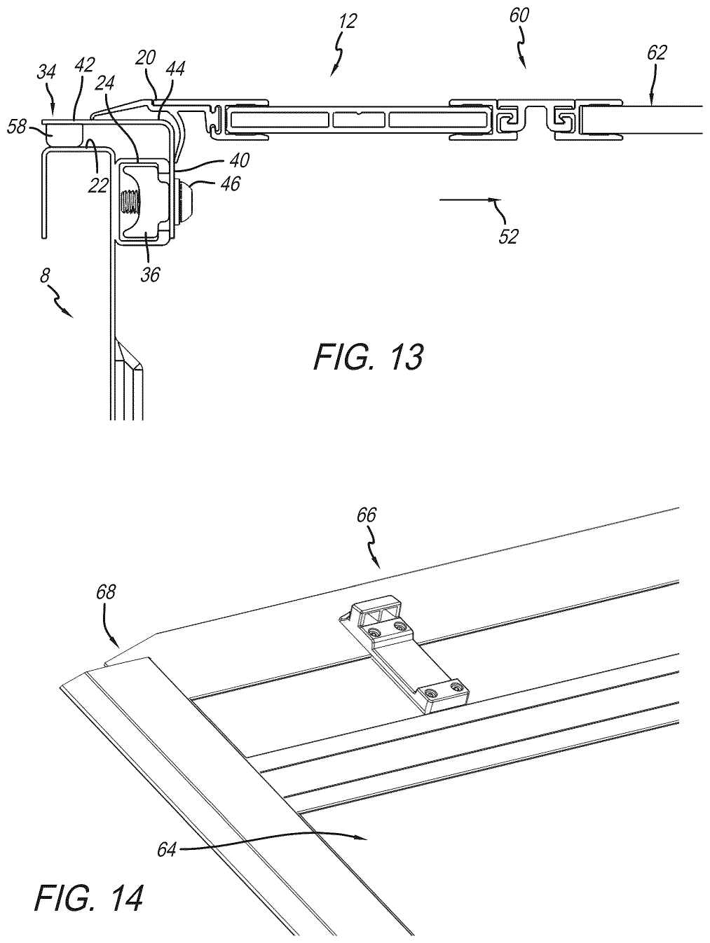

A detail exploded perspective view of cargo box 2, with bulkhead panel 12 and contour filler bracket 34, similar to the view shown in FIG. 1, is shown in FIG. 5. This view shows bulkhead 8 with the irregularly shaped profile illustratively defined by top edge 22 and angled portions 16 and 18. In the illustrative embodiment, track 24 includes a plurality of blocks 36 each of which can be slid along track 24 and aligned with corresponding openings 38 disposed through flange portion 40 of contour filler bracket 34. Illustratively perpendicular to flange portion 40 is top ledge 42, which follows the contour of top edge 22 of bulkhead 8. Top ledge 42 illustratively rests on top of top edge 22 and is configured to extend back toward cargo box opening 14 to provide clearance for track 24 and provide a linear surface 44 that corresponds to top leading edge 20 of bulkhead panel 12 (see, also, FIG. 13). Each of fasteners 46 extends through one of the openings 38 and engages one of blocks 36 to secure contour filler bracket 34 to bulkhead 8 and, particularly, to top edge 22 of bulkhead 8. Contoured filler bracket 34 will, thus, sit between bulkhead panel 12 of the tonneau cover and bulkhead 8.

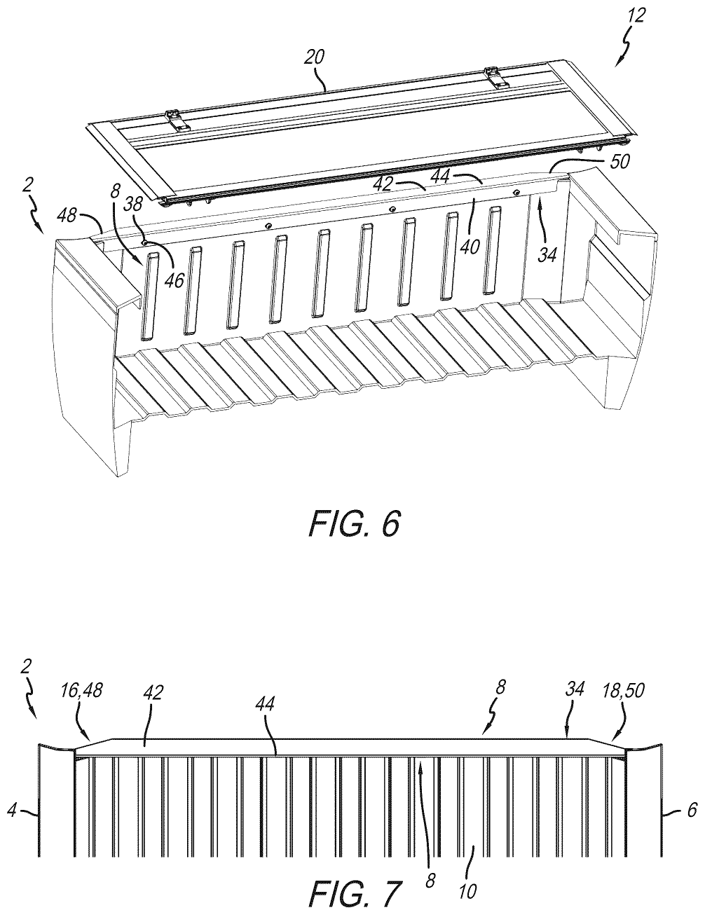

A perspective partially exploded view of cargo box 2, similar to that shown in FIGS. 1 and 5, is shown in FIG. 6. Here, bulkhead panel 12 is separated from cargo box 2 while contour filler bracket 34 is shown installed onto bulkhead 8. Each of fasteners 46 is disposed through openings 38 in flange portion 40 of contour filler bracket 34 and secured to a block 36 fitted in track 24 (see, also, FIG. 13). Contour filler bracket 34 provides a top ledge portion 42 having a linear surface portion 44 that compliments leading edge 20 of bulkhead panel 12. In illustrative embodiments, the remainder of the tonneau cover can be shortened slightly to pull bulkhead panel 12 slightly back away from bulkhead 8 so linear leading edge 20 can be positioned adjacent linear surface 44 (see, also, FIG. 13). However, pulling bulkhead panel 12 further away from bulkhead 8 will not create an opening between bulkhead 8 and leading edge 20 because of contour filler bracket 34. Furthermore, top ledge 42 may include angled portions 48 and 50 that correspond to angled portions 16 and 18, respectively, on bulkhead 8 so they have matching profiles.

A top view of the forward end portion of cargo box 2, similar to that shown in FIG. 2, is shown in FIG. 7. In contrast to that shown in FIG. 2, contour filler bracket 34 is located on top of top edge 22 of bulkhead 8. This view demonstrates how angled portions 48 and 50 coincide with angled portions 16 and 18 of bulkhead 8. Also shown is how linear surface 44 extends rearward from top ledge 42 for purposes of providing a linear structure that will coincide with leading edge 20 of bulkhead panel 12.

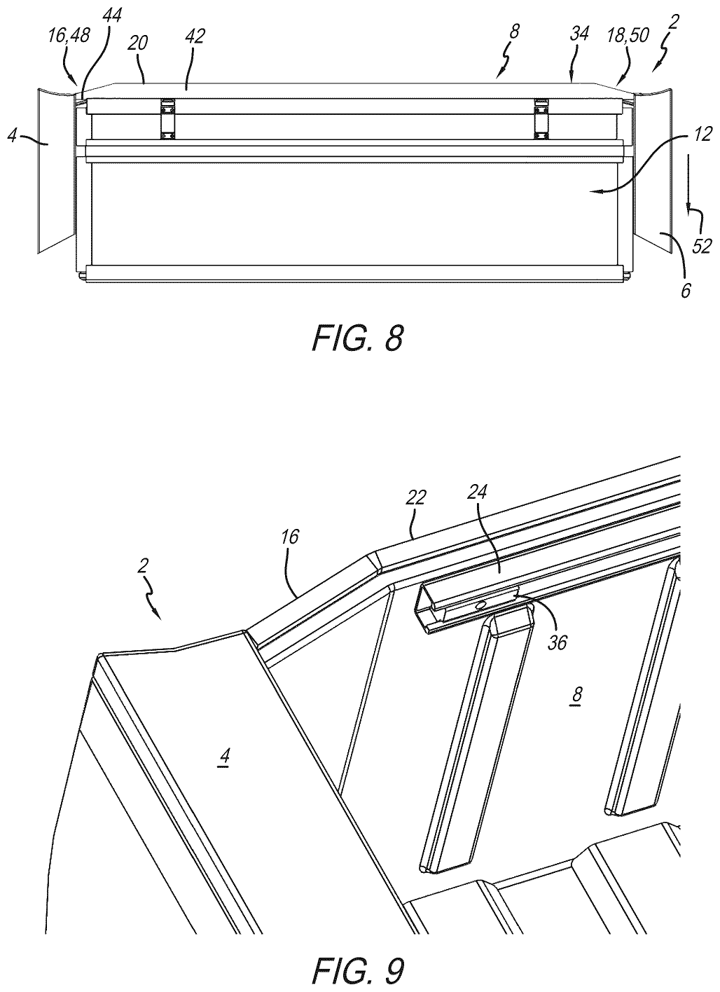

Another top view of the forward portion of cargo box 2, with bulkhead panel 12 from a tonneau cover located thereon, similar to FIG. 4, is shown in FIG. 8. This view differs from that of FIG. 4, in that bulkhead panel 12 is pulled rearward in direction 52, as well as contour filler bracket 34 placed on top of bulkhead 8. For demonstrative purposes, side seals 54 and 56, that overlap both bulkhead panel 12 and respective sidewalls 4 and 6, have been removed for demonstrable purposes. In this view, however, it becomes clear how leading edge 20 of bulkhead panel 12 overlaps linear surface 44 of top ledge 42 of contour filler bracket 34. As demonstrated, this provides a straight or linear surface by which leading edge 20 can overlap without extending beyond bulkhead 8 and, in particular, angled portions of 16 and 18 as is shown in FIG. 4. Angled portions 48 and 50 of contour filler bracket 34 are shown having the same contour as angled portions 16 and 18 of bulkhead 8. This combination maintains the non-linear contoured profile of bulkhead 8 while still allowing the linear leading edge 20 of bulkhead panel 12 to be positioned over correspondingly linear surface 44 of contour filler bracket 34. This results in preventing space to form between bulkhead 8 and leading edge 20 while still maintaining the nonlinear profile. It is appreciated that because the bulkhead panel is moved rearward in direction 52, the remainder of the cover, whether multiple folding panels, a single folding or rolling panel, cannot be trimmed to shorten its length to accommodate bulkhead panel 12 being moved. The net effect is that the tonneau cover does not overlap or otherwise interfere with the nonlinear contour of bulkhead 8, while still covering cargo box 2, pursuant to the tonneau cover's normal function.

Another detail perspective view of cargo box 2, including sidewalls 4 and bulkhead 8, like that shown in FIG. 3, is also shown and FIG. 9. This view differs from FIG. 3 in that block 36 is shown located within track 24. It will be these blocks 36 that contour filler bracket 34 will be illustratively attached to in order to secure same to bulkhead 8.

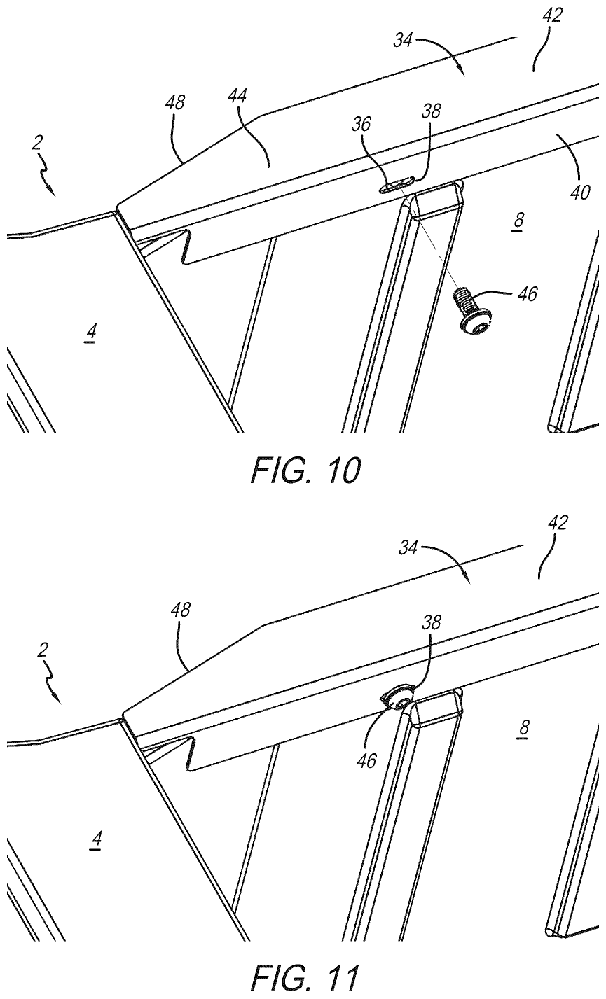

To that end, additional detail perspective views of cargo box 2, including sidewall 4 and bulkhead 8, similar to FIGS. 3 and 9, are also shown in FIGS. 10 and 11. Here, in contrast to the views of FIGS. 3 and 9, contour filler bracket 34 is fitted onto bulkhead 8. The view in FIG. 10 shows contour filler bracket 34 seated on bulkhead 8, but without a fastener yet disposed through opening 38 of flange portion 40 of contour filler bracket 34. In this view, block 36 is visible through opening 38 and can receive fastener 46. This view also shows angled portion 48, as well as linear surface 44 of top ledge 42, which provides the linear portion of contour filler bracket 34 that will coincide with leading edge 20 of bulkhead panel 12. In FIG. 11, fastener 46 is shown disposed through opening 38 and is threadably secured to block 36, thereby securing contour filler bracket 34 onto bulkhead 8. With multiple fasteners 46 disposed through corresponding openings 38 to secure to blocks 36 (see, also, FIG. 5), contour filler bracket 34 is secured onto bulkhead 8.

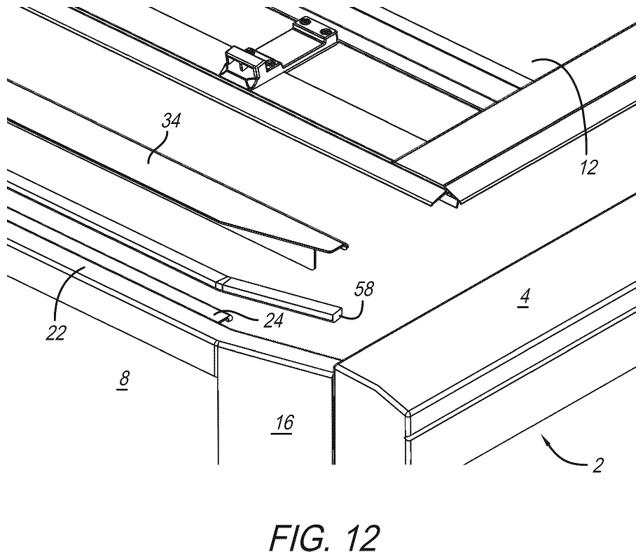

A detail perspective view of the forward corner of cargo box 2, in partial exploded view, is shown in FIG. 12. Here, bulkhead panel 12, as well as contour filler bracket 34 are shown separated from cargo box 2. Also shown in this view is a gasket 58 that serves as a seal between top edge 22 of bulkhead 8 and the underside of contour filler bracket 34 to prevent moisture from seeping in between.

A side sectional view of bulkhead 8 and tonneau cover 60, with bulkhead panel 12 coupled thereto, is shown in FIG. 13. This view also shows contour filler bracket 34 attached to bulkhead 8 via block 36 fitted within track 24, fastener 46 disposed through flange portion 40 of contour filler bracket 34, and threaded into block 36. This view also demonstrates how leading edge 20 of bulkhead panel 12 overlaps linear surface 44 of top ledge 42, which provides the corresponding linear surface between contour filler bracket 34 and bulkhead panel 12. Gasket 58 is also shown positioned between contour filler bracket 34 and top edge 22 of bulkhead 8 to provide a sealing function therebetween. Again, it is appreciated that contour filler bracket 34, providing the linear surface 44 that coincides with leading edge 20 of bulkhead panel 12, provides coverage between bulkhead 8 and bulkhead panel 12 without interfering with the irregular shape of bulkhead 8. Shifting tonneau cover 60 rearward in direction 52 means that folding panels, such as folding panel 62, can have its length trimmed if needed to accommodate the reduced length needed for a tonneau cover 60 in view of this new positioning. This is the same as if there were only a single folding or rolling panel as well.

Another illustrative embodiment of the present disclosure provides a bulkhead panel with a contoured leading edge that coincides with the top profile of a nonlinear bulkhead. In this embodiment, there is no longer a need for a contour filler panel nor reducing the length of folding or rolling panels of the tonneau cover because of the leading edge of the bulkhead panel approximating or matching the contour of the top edge of the bulkhead.

A detail perspective view of a portion of bulkhead panel 64 is shown in FIG. 14. In this view, bulkhead panel 64 is similar to that of bulkhead panel 12 of the prior embodiment, except that bulkhead panel 64 includes a contoured leading edge 66 having an illustrative angle portions 68 that at least approximates, if not matches, the contour of top edge 22 of bulkhead 8, including angled portions 16. It is appreciated that contoured leading edge 66 may have another angled portion (not shown) that at least approximates, if not matches, angled portion 18 on the opposite side of bulkhead panel 64. In this way, bulkhead panel 64 can fit on top of cargo box 2 and fully cover its opening with contoured leading edge 66 approximating or matching the nonlinear profile of bulkhead 8. It is further appreciated that the particular angled portion or portions of both the top edge of bulkhead 8 and contoured leading edge 66 are illustrative. Other angles or nonlinear designs for both the bulkhead, the leading edge of the bulkhead panel, as well as the contour filler panel in the prior embodiment, are illustrative. Contoured leading edge 66 may encompass other nonlinear designs and are contemplated to be within the scope of this disclosure.

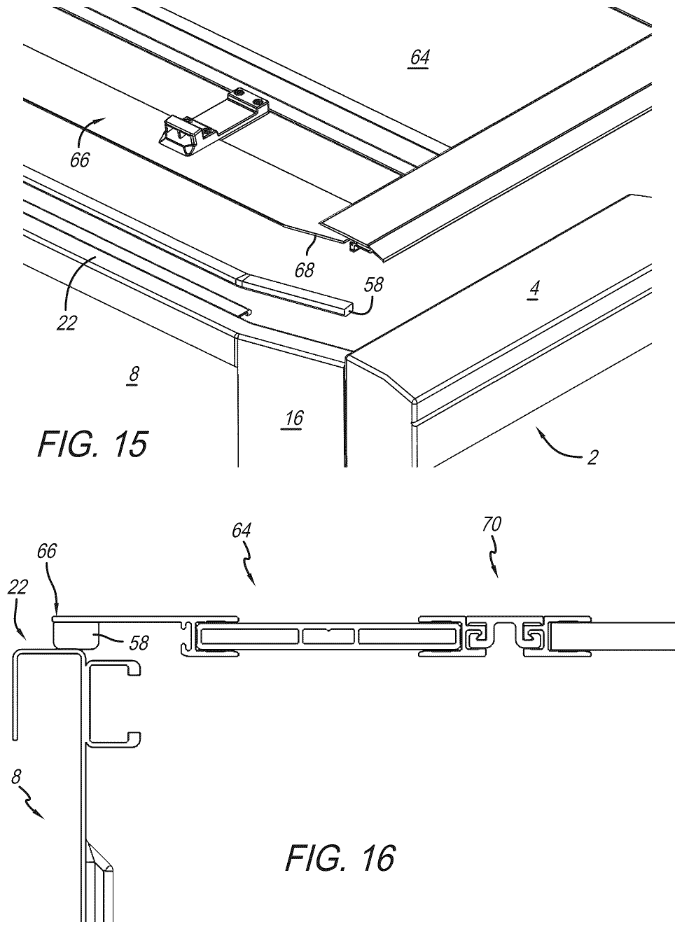

A detail perspective view of the front corner of cargo box 2 is shown in FIG. 15. This view is similar to that of FIG. 12 in that a gasket 58 can be placed between top edge 22 of bulkhead 8 and the underside of contoured leading edge 66 of bulkhead panel 64. This provides a seal between the bulkhead panel and the bulkhead to inhibit moisture from seeping in between.

A side sectional view of bulkhead 8 and tonneau cover 70 is shown in FIG. 16. This view is similar to that shown in FIG. 13, except that rather than contour filler bracket 34 needing to be attached to bulkhead 8, contoured leading edge 66 overlaps top edge 22 of bulkhead 8. Because contoured leading edge 66 follows the contour of top edge 22, no linear surface (like linear surface 44 of contour filler bracket 34) is needed for bulkhead panel 64 to effectively shroud cargo box 2, particularly, at the leading edge. Contoured leading edge 66 is shown overlapping a portion of top edge 22. Gasket 58 is located between contoured leading edge 66 and top edge 22 for providing a seal therebetween.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that any subject matter disclosed in this non-provisional patent application that may differ from the priority application, the disclosure from this non-provisional patent application controls.

What is claimed:

1. A contour filler bracket for use on a bulkhead of a cargo box of a pickup truck, wherein the bulkhead has a nonlinear top edge contour, and a tonneau cover panel, the contour filler bracket comprising:
a longitudinally extending bracket member having a front edge and a rear edge spaced apart from the front edge;
wherein the bracket member is configured to extend substantially a length of the nonlinear top edge contour of the bulkhead between spaced apart sidewalls of the cargo box;
wherein at least a portion of the bracket member is seated on top of the bulkhead;
wherein the front edge of the bracket member at least approximates the nonlinear top edge contour of the bulkhead;
wherein the rear edge of the bracket member is linearly extending; and
wherein a front edge of the tonneau cover panel is configured to overlap the rear edge of the bracket member to shroud a portion of the cargo box adjacent the bulkhead.

2. The contour filler bracket of claim 1, wherein the bracket member includes a ledge portion extending between the front edge and the rear edge, and a flange portion that extends from the rear edge of the bracket member.

3. The contour filler bracket of claim 2, wherein the flange portion extends transverse with respect to the ledge portion.

4. The contour filler bracket of claim 2, wherein the flange portion is secured to the bulkhead.

5. The contour filler bracket of claim 3, wherein the flange portion includes at least one opening configured to receive a fastener that secures to the bulkhead.

6. The contour filler bracket of claim 1, further comprising a gasket that extends longitudinally under the bracket member.

7. The contour filler bracket of claim 2, wherein the flange portion secures to the bulkhead.

8. The contour filler bracket of claim 6, wherein the gasket is configured to be located between the bracket member and the bulkhead.

9. A contour filler bracket for use on a bulkhead of a cargo box of a pickup truck, wherein the bulkhead has a nonlinear top edge contour, and a tonneau cover panel, the contour filler bracket comprising:
a longitudinally extending bracket member having a front edge and a rear edge spaced apart from the front edge;
wherein the front edge of the bracket member at least approximates at least a portion of the nonlinear top edge contour of the bulkhead; and
wherein a front edge of the tonneau cover panel is configured to overlap the rear edge of the bracket member to shroud at least a portion of the cargo box adjacent the bulkhead.

10. The contour filler bracket of claim 9, wherein the bracket member is configured to extend substantially a length of the nonlinear top edge contour of the bulkhead between spaced apart sidewalls of the cargo box.

11. The contour filler bracket of claim 9, wherein at least a portion of the bracket member is seated on top of the bulkhead.

12. The contour filler bracket of claim 9, wherein the rear edge of the bracket member is linearly extending.

13. The contour filler bracket of claim 9, wherein the bracket member includes a ledge portion extending between the front edge and the rear edge, and a flange portion that extends from the rear edge of the bracket member.

14. The contour filler bracket of claim 13, wherein the flange portion extends transverse with respect to the ledge portion.

15. The contour filler bracket of claim 14, wherein the flange portion is secured to the bulkhead.

16. The contour filler bracket of claim 9, further comprising a gasket that extends longitudinally under the bracket member.

17. The contour filler bracket of claim 16, wherein the gasket is configured to be located between the bracket member and the bulkhead.

18. A tonneau cover assembly for use on a cargo box of a pickup truck having a bulkhead with a nonlinear top edge contour, the tonneau cover assembly comprising:
a bulkhead panel configured to shroud at least a portion of the cargo box;
wherein the bulkhead panel includes a nonlinear leading edge that at least approximates at least a portion of the nonlinear top edge contour of the bulkhead; and
wherein at least a portion of the nonlinear leading edge the bulkhead panel is configured to overlap at least a portion of the bulkhead to shroud the at least the portion of the cargo box adjacent the bulkhead.

19. The tonneau cover assembly of claim 18, further comprising a gasket that extends longitudinally under the bulkhead panel.

20. The tonneau cover assembly of claim 19, wherein the gasket is configured to be located between the bulkhead panel and the bulkhead.
